(19) United States
(12) Patent Application Publication
(10) Pub. No.: US 2017/0208622 A1
(43) Pub. Date: Jul. 20, 2017

(54) DISTRIBUTING DIGITAL COMMUNICATIONS SIGNALS IN ANALOG DISTRIBUTED ANTENNA SYSTEMS (DASS) USING PROGRAMMABLE HEAD-END UNITS

(71) Applicant: Corning Optical Communications Wireless Ltd, Airport City (IL)

(72) Inventors: Gavriel Mizrahi, Tel Aviv (IL); Ofer Nisan, Netanya (IL); Dror Ben-Shlomo, Modi'in (IL)

(21) Appl. No.: 15/473,827

(22) Filed: Mar. 30, 2017

Related U.S. Application Data
(63) Continuation of application No. PCT/IL2015/051205, filed on Dec. 13, 2015.
(60) Provisional application No. 62/093,640, filed on Dec. 18, 2014.

(51) Int. Cl. H04W 74/00

(52) U.S. Cl. CPC H04W 74/002; H04W 88/085

(57) ABSTRACT

Embodiments of the disclosure relate to distributing digital communications signals in analog distributed antenna systems (DASs) using programmable head-end units. In one aspect, a programmable head-end unit is configured to convert downlink digital communications signals to downlink analog radio frequency (RF) communications signals for distribution to remote unit groups in the analog DAS. Further, the programmable head-end unit is configured to convert uplink analog RF communications signals to uplink digital communications signals to be distributed to the digital signal sources. The programmable head-end unit is also configured to route the digital communications signals between the digital signal sources and the remote unit groups based on programmably defined routing criteria, thus allowing the programmable head-end unit to be software-defined. By providing the programmable head-end unit, the analog DAS can be configured to interface with the digital signal sources to compatibly distribute digital communications signals.

### PRIORITY APPLICATION

This application is a continuation of International Application No. PCT/IL15/051205 filed on Dec. 13, 2015 and claims the benefit of priority under 35 U.S.C. §119 of U.S. Provisional Application No. 62/093,640, filed on Dec. 18, 2014, the content of which are relied upon and incorporated herein by reference in their entireties.

### BACKGROUND

The disclosure relates generally to distribution of communications signals in a distributed antenna system (DAS), and more particularly to distributing digital communications signals in analog DASs using programmable head-end units.

Wireless customers are increasingly demanding digital data services, such as streaming video signals. Concurrently, some wireless customers use their wireless devices in areas that are poorly served by conventional cellular networks, such as inside certain buildings or areas where there is little cellular coverage. One response to the intersection of these two concerns has been the use of DASs. DASs can be particularly useful when deployed inside buildings or other indoor environments where client devices may not otherwise be able to effectively receive radio frequency (RF) signals from a source. DASs include remote antenna units (RAUs) configured to receive and transmit communications signals to client devices within the antenna range of the RAUs.

A typical DAS comprises a head-end unit communicatively coupled to one or more remote unit groups, each comprising at least one remote unit. The remote unit may be a remote antenna unit that is configured to wirelessly distribute communications signals to and from the head-end unit. The head-end unit is configured to receive and distribute the communications signals to a variety of wireless services, such as wideband code division multiple access (WCDMA), long term evolution (LTE), and wireless local area network (WLAN) communications services. To distribute such wireless communications services in a DAS, the wireless communications services can be provided in the form of analog RF communications signals and/or digital communications signals to the head-end unit of the DAS. Thus, the DAS may be configured to receive and distribute the analog RF communications signals and/or digital communications signals in either analog or digital form. Analog RF communications signals may be directly modulated onto a carrier signal for transmission over a communications medium. Digital communications signals, in contrast, are signals generated by sampling and digitizing an analog communications signal before modulating onto the carrier signal. DASs configured to directly distribute analog RF communications signals may be referred to as analog DASs. DASs configured to directly distribute digital communications signals may be referred to as digital DASs.

No admission is made that any reference cited herein constitutes prior art. Applicant expressly reserves the right to challenge the accuracy and pertinency of any cited documents.

### SUMMARY

Embodiments of the disclosure relate to distributing digital communications signals in analog distributed antenna systems (DASs) using programmable head-end units. In certain analog DASs disclosed herein, a programmable head-end unit is provided and communicatively coupled to one or more remote unit groups over a communications medium. The analog DAS is configured to interface with digital signal sources, such as baseband units (BBUs) for example, and compatibly distribute digital communications signals to analog DAS components. In this regard, in one aspect, the programmable head-end unit is configured to convert downlink digital communications signals received from the digital signal sources to downlink analog RF communications signals for distribution to the one or more remote unit groups in the analog DAS. Further, the programmable head-end unit is configured to convert uplink analog RF communications signals received from the one or more remote unit groups to uplink digital communications signals to be distributed to the digital signal sources. In another aspect, the programmable head-end unit is configured to route the digital communications signals between any of the digital signal sources and any of the one or more remote unit groups based on programmably defined routing criteria, thus allowing the programmable head-end unit to be software-defined to provide more flexibility in routing the digital communications signals. By providing the programmable head-end unit, the analog DAS can be configured to interface with the digital signal sources to compatibly distribute digital communications signals.

One embodiment of the disclosure relates to a programmable head-end unit configured to distribute multi-band/multi-channel digital communications signals to one or more remote unit groups in an analog DAS. The programmable head-end unit comprises one or more downlink signal-processing paths each associated with a respective remote unit group, wherein each remote unit group comprises at least one remote unit. The programmable head-end unit also comprises a programmable digital signal router. The programmable digital signal router is configured to receive one or more downlink digital communications signals from one or more digital signal sources, wherein each of the one or more downlink digital communications signals comprises one or more logical channels. The programmable digital signal router is also configured to programmably assign each of the one or more logical channels to one or more logical channel sets, wherein each of the one or more logical channel sets is associated with a downlink signal-processing path among the one or more downlink signal-processing paths. The programmable digital signal router is also configured to generate a plurality of downlink digital baseband signals each corresponding to a respective logical channel among the one or more logical channels comprised in the received one or more downlink digital communications signals. The programmable digital signal router is also configured to route each of the plurality of downlink digital baseband signals to at least one of the one or more downlink signal-processing paths based on assignment of the respective logical channel to the one or more logical channel sets. Each of the one or more downlink signal-processing paths is configured to receive one or more downlink digital baseband signals among the plurality of downlink digital baseband signals from the programmable digital signal router. Each of the one or more downlink signal-processing paths is also configured to convert the one or more downlink digital baseband signals into a downlink analog radio frequency (RF) signal to be provided to the respective remote unit group associated with the downlink signal-processing path.

An additional embodiment of the disclosure relates to a method for distributing multi-band/multi-channel digital communications signals in an analog DAS. The method comprises configuring one or more downlink signal-processing paths. The method also comprises associating each of the one or more downlink signal-processing paths with a respective remote unit group. The method also comprises receiving one or more downlink digital communications signals from one or more digital signal sources, respectively, wherein each of the one or more downlink digital communications signals comprises one or more logical channels. The method also comprises programmably assigning each of the one or more logical channels to one or more logical channel sets, wherein each of the one or more logical channel sets is associated with a downlink signal-processing path among the one or more downlink signal-processing paths. The method also comprises generating a plurality of downlink digital baseband signals from the one or more downlink digital communications signals, wherein each of the plurality of downlink digital baseband signals corresponds to a respective logical channel among the one or more logical channels comprised in the received one or more downlink digital communications signals. The method also comprises routing each of the plurality of downlink digital baseband signals to at least one of the one or more downlink signal-processing paths based on assignment of the respective logical channel to the one or more logical channel sets. The method also comprises converting one or more received downlink digital baseband signals by each of the one or more downlink signal-processing paths to generate a downlink analog radio frequency (RF) signal to be provided to the respective remote unit group associated with the downlink signal-processing path.

An additional embodiment of the disclosure relates to an analog DAS. The analog DAS comprises one or more remote unit groups each comprising at least one remote unit. The analog DAS also comprises a programmable head-end unit coupled to the one or more remote unit groups by at least one downlink communications medium and at least one uplink communications medium. The programmable head-end unit comprises a programmable digital signal router communicatively coupled to one or more digital signal sources. The programmable head-end unit also comprises one or more downlink signal-processing paths communicatively coupled to the programmable digital signal router. The programmable digital signal router is configured to receive one or more downlink digital communications signals from the one or more digital signal sources, wherein each of the one or more downlink digital communications signals comprises one or more logical channels. The programmable digital signal router is also configured to programmably assign each of the one or more logical channels to one or more logical channel sets, wherein each of the one or more logical channel sets is associated with a downlink signal-processing path among the one or more downlink signal-processing paths. The programmable digital signal router is also configured to generate a plurality of downlink digital baseband signals each corresponding to a respective logical channel among the one or more logical channels comprised in the received one or more downlink digital communications signals. The programmable digital signal router is also configured to route each of the plurality of downlink digital baseband signals to at least one of the one or more downlink signal-processing paths based on assignment of the respective logical channel to the one or more logical channel sets. The programmable head-end unit also comprises one or more digital-to-analog converters (DACs) each coupled to a respective downlink signal-processing path among the one or more downlink signal-processing paths. The programmable head-end unit also comprises one or more uplink signal-processing paths communicatively coupled to the programmable digital signal router. The programmable head-end unit also comprises one or more analog-to-digital converters (ADCs) each coupled to an uplink signal-processing path among the one or more uplink signal-processing paths.

An additional embodiment of the disclosure relates to a non-transitory computer-readable medium having stored thereon computer executable instructions. The computer executable instructions, when executed, cause a processor in a programmable head-end unit in a distributed antenna system (DAS) to determine reception of one or more downlink digital communications signals from one or more digital signal sources, wherein each of the one or more downlink digital communications signals comprises one or more logical channels. The computer executable instructions, when executed, also cause the processor in the programmable head-end unit to programmably assign each of the one or more logical channels to one or more logical channel sets, wherein each of the one or more logical channel sets is associated with a downlink signal-processing path among one or more downlink signal-processing paths. The computer executable instructions, when executed, also cause the processor in the programmable head-end unit to generate a plurality of downlink digital baseband signals, wherein each of the plurality of downlink digital baseband signals corresponds to a respective logical channel. The computer executable instructions, when executed, also cause the processor in the programmable head-end unit to route each of the plurality of downlink digital baseband signals to at least one of the one or more downlink signal-processing paths based on assignment of the respective logical channel to the one or more logical channel sets.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary analog distributed antenna system (DAS);

FIG. 2 is a schematic diagram of an exemplary analog DAS comprising a programmable head-end unit configured to distribute digital communications signals between one or more digital signal sources and one or more remote unit groups;

FIG. 3 is a schematic diagram of the programmable head-end unit in FIG. 2 configured to bridge the analog DAS in FIG. 2 to the one or more digital signal sources;

FIG. 4A is a flowchart of an exemplary downlink distribution process performed at the programmable head-end unit in FIG. 3 to distribute downlink digital communications signals in the analog DAS in FIG. 2;

FIG. 4B is a flowchart of an exemplary uplink distribution process performed at the programmable head-end unit in FIG. 3 to distribute uplink digital communications signals in the analog DAS in FIG. 2;

FIG. 5A is a schematic diagram of an exemplary downlink signal-processing path of the programmable head-end unit in FIG. 3, wherein the downlink signal-processing path is configured to generate a respective downlink analog radio frequency (RF) signal for distribution to a respective remote unit group;

FIG. 5B is a schematic diagram of an exemplary downlink modulation circuit in the downlink signal-processing path in FIG. 5A, wherein the downlink modulation circuit is configured to modulate a downlink digital baseband signal comprising a downlink in-phase (I) signal and a downlink quadrature (Q) signal;

FIG. 6A is a schematic diagram of an exemplary uplink signal-processing path of the programmable head-end unit in FIG. 3, wherein the uplink signal-processing path is configured to convert a respective uplink analog RF signal into one or more respective uplink digital baseband signals;

FIG. 6B is a schematic diagram of an exemplary uplink demodulation circuit in the uplink signal-processing path in FIG. 6A, wherein the uplink demodulation circuit is configured to demodulate an uplink digital RF signal to generate an uplink digital baseband signal comprising an uplink I signal and an uplink Q signal;

FIG. 7 is a schematic diagram of an exemplary double-conversion downlink signal-processing path of the programmable head-end unit in FIG. 3, wherein the double-conversion downlink signal-processing path is configured to generate a respective downlink analog RF signal for distribution to a respective remote unit group;

FIG. 8 is a schematic diagram of an exemplary double-conversion uplink signal-processing path of the programmable head-end unit in FIG. 3, wherein the double-conversion uplink signal-processing path is configured to convert a respective uplink analog RF signal into one or more respective uplink digital baseband signals;

FIG. 9 is a partially schematic cut-away diagram of an exemplary building infrastructure in which an analog DAS, which can include the analog DASs in FIG. 2 or 3, includes a digital signal interface in a programmable head-end unit to support distribution of digital communications signals, can be employed; and

FIG. 10 is a schematic diagram of a generalized representation of an exemplary control circuit in the form of a controller that can be included in an analog DAS to control a programmable head-end unit to distribute digital communications signals in the analog DAS, wherein the exemplary computer system is adapted to execute instructions from an exemplary computer readable medium.

### DETAILED DESCRIPTION

Various embodiments will be further clarified by the following examples.

Embodiments of the disclosure relate to distributing digital communications signals in analog distributed antenna systems (DASs) using programmable head-end units. In certain analog DASs disclosed herein, a programmable head-end unit is provided and communicatively coupled to one or more remote unit groups over a communications medium. The analog DAS is configured to interface with digital signal sources, such as baseband units (BBUs) for example, and compatibly distribute digital communications signals to analog DAS components. In this regard, in one aspect, the programmable head-end unit is configured to convert downlink digital communications signals received from the digital signal sources to downlink analog RF communications signals for distribution to the one or more remote unit groups in the analog DAS. Further, the programmable head-end unit is configured to convert uplink analog RF communications signals received from the one or more remote unit groups to uplink digital communications signals to be distributed to the digital signal sources. In another aspect, the programmable head-end unit is configured to route the digital communications signals between any of the digital signal sources and any of the one or more remote unit groups based on programmably defined routing criteria, thus allowing the programmable head-end unit to be software-defined to provide more flexibility in routing the digital communications signals. By providing the programmable head-end unit, the analog DAS can be configured to interface with the digital signal sources to compatibly distribute digital communications signals.

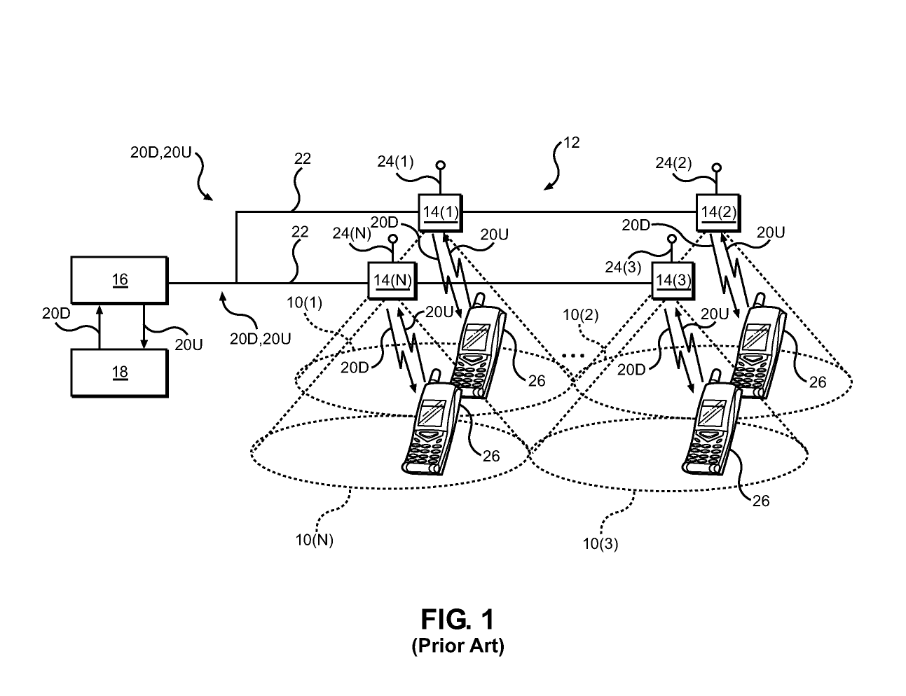

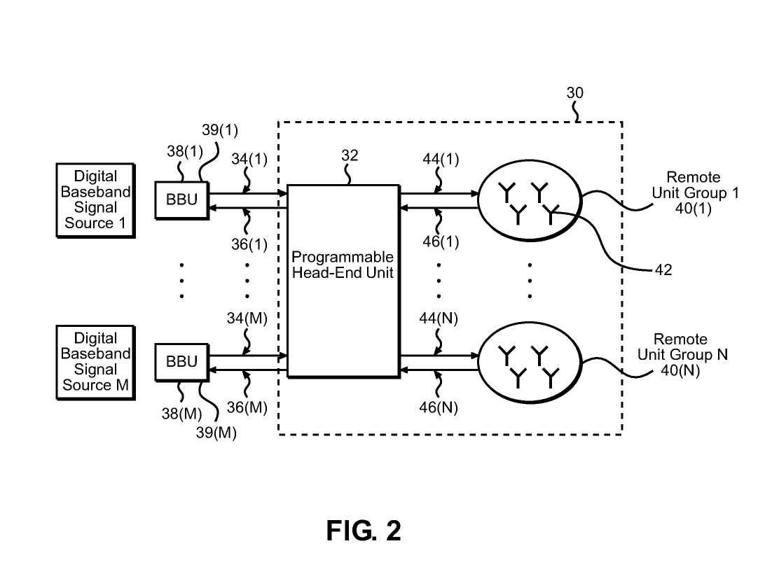

Before discussing examples of a programmable head-end unit supporting digital communications signals distribution in an analog DAS starting at FIG. 2, a discussion of an exemplary analog DAS that employs a communications medium to support only analog wireless communications services to a plurality of remote units is first provided with reference to FIG. 1. The discussion of specific exemplary aspects of supporting digital communications signals distribution in an analog DAS using a programmable head-end unit is provided starting at FIG. 2.

In this regard, FIG. 1 illustrates distribution of communications services to coverage areas 10(1)-10(N) of an analog DAS 12, wherein ‘N’ is the number of coverage areas. These communications services can include cellular services, wireless services such as radio frequency (RF) identification (RFID) tracking, Wireless Fidelity (Wi-Fi), local area network (LAN), and combinations thereof, as examples. The coverage areas 10(1)-10(N) may be remotely located. In this regard, the remote coverage areas 10(1)-10(N) are created by and centered on remote antenna units 14(1)-14(N) connected to a head-end unit 16 (e.g., a head-end controller or head-end equipment or central unit). The head-end unit 16 may be communicatively coupled to a base transceiver station (BTS) 18. In this regard, the head-end unit 16 receives downlink RF communications signals 20D from the BTS 18 to be distributed to the remote antenna units 14(1)-14(N). The remote antenna units 14(1)-14(N) are configured to receive the downlink RF communications signals 20D from the head-end unit 16 over a communications medium 22 to be distributed to the respective remote coverage areas 10(1)-10(N) of the remote antenna units 14(1)-14(N). In a non-limiting example, the communications medium 22 may be a wired communications medium, a wireless communications medium, or an optical fiber-based communications medium. Each remote antenna unit 14(1)-14(N) may include an RF transmitter/receiver (not shown) and a respective antenna 24(1)-24(N) operably connected to the RF transmitter/receiver to wirelessly distribute the communications services to client devices 26 within their respective remote coverage areas 10(1)-10(N). The remote antenna units 14(1)-14(N) are also configured to receive uplink RF communications signals 20U from the client devices 26 in their respective remote coverage areas 10(1)-10(N) to be distributed to the BTS 18. The size of a given remote coverage area 10(1)-10(N) is determined by the amount of RF power transmitted by the respective remote antenna unit 14(1)-14(N), the receiver sensitivity, antenna gain and the RF environment, as well as by the RF transmitter/receiver sensitivity of the client device 26. The client devices 26 usually have a fixed maximum RF receiver sensitivity, so that the above-mentioned properties of the remote antenna units 14(1)-14(N) mainly determine the size of their respective remote coverage areas 10(1)-10(N).

In the analog DAS 12 in FIG. 1, the downlink RF communications signal 20D and the uplink RF communications signal 20U are both analog RF communications signals that can be directly modulated onto a carrier signal (e.g., electrical signal, radio signal, light signal, etc.) appropriate for distribution over the communications medium 22. In this regard, a digital communications signal cannot be directly distributed in the analog DAS 12 over the communications medium 22. It may be desirable to be able to distribute digital communications signals received from digital signal sources in the analog DAS 12. Benefits of digital signal sources include smaller size, lower cost, reduced power consumption, and improved signal quality. In this regard, as described in more detail below, FIG. 2 illustrates analog DAS 30 configured to distribute digital communications signals received from digital signal sources.

FIG. 2 is a schematic diagram of an exemplary analog DAS 30 configured to distribute digital communications signals received from digital signal sources. The analog DAS 30 includes a programmable head-end unit 32 configured to distribute one or more downlink digital communications signals 34(1)-34(M) and one or more uplink digital communications signals 36(1)-36(M) between one or more digital signal sources 38(1)-38(M) and one or more remote unit groups 40(1)-40(N). ‘M’ and ‘N’ can be any real positive integers. Each of the one or more remote unit groups 40(1)-40(N) comprises at least one remote unit 42. The remote units 42 may be remote antenna units that are configured to wirelessly transmit and receive communications signals. In a non-limiting example, the programmable head-end unit 32 in the analog DAS 30 in FIG. 2 may be software-defined. In a non-limiting example, the one or more remote unit groups 40(1)-40(N) are formed by clustering the at least one remote unit 42 based on logical or physical associations. For example, the at least one remote unit 42 may be associated with one of the one or more remote unit groups 40(1)-40(N) based on wireless technology, RF spectrum (e.g., band or channel) usage, and/or installation location. In another non-limiting example, the at least one remote unit 42 may be associated with more than one of the one or more remote unit groups 40(1)-40(N).

With continuing reference to FIG. 2, in a non-limiting example, the one or more digital signal sources 38(1)-38(M) are one or more digital baseband units (BBUs) 39(1)-39(M). The BBUs 39(1)-39(M) are configured to exchange the one or more downlink digital communications signals 34(1)-34(M) and the one or more uplink digital communications signals 36(1)-36(M) with the analog DAS 30. According to another non-limiting example, the one or more downlink digital communications signals 34(1)-34(M) and the one or more uplink digital communications signals 36(1)-36(M) are all digital baseband signals encoded in conformance with a common public radio interface (CPRI) specification. In this regard, each of the one or more downlink digital communications signals 34(1)-34(M) and each of the one or more uplink digital communications signals 36(1)-36(M) may be associated with one or more logical channels (not shown) (e.g., logical channel addresses). As further discussed later in this disclosure, the one or more logical channels associated with each of the one or more downlink digital communications signals 34(1)-34(M) may be used by the programmable head-end unit 32 to route the one or more downlink digital communications signals 34(1)-34(M) to the one or more remote unit groups 40(1)-40(N).

With continuing reference to FIG. 2, the programmable head-end unit 32 is configured to convert the one or more downlink digital communications signals 34(1)-34(M) and route each of the one or more downlink digital communications signals 34(1)-34(M) based on the one or more respective logical channels to generate one or more downlink analog RF signals 44(1)-44(N) for distribution to the one or more remote unit groups 40(1)-40(N). The programmable head-end unit 32 is also configured to convert one or more uplink analog RF signals 46(1)-46(N) and route the one or more uplink analog RF signals 46(1)-46(N) based on the one or more associated logical channels to generate the one or more uplink digital communications signals 36(1)-36(M) for distribution to the one or more digital signal sources 38(1)-38(M). As such, the programmable head-end unit 32 serves as a gateway between the analog DAS 30 and the one or more digital signal sources 38(1)-38(M).

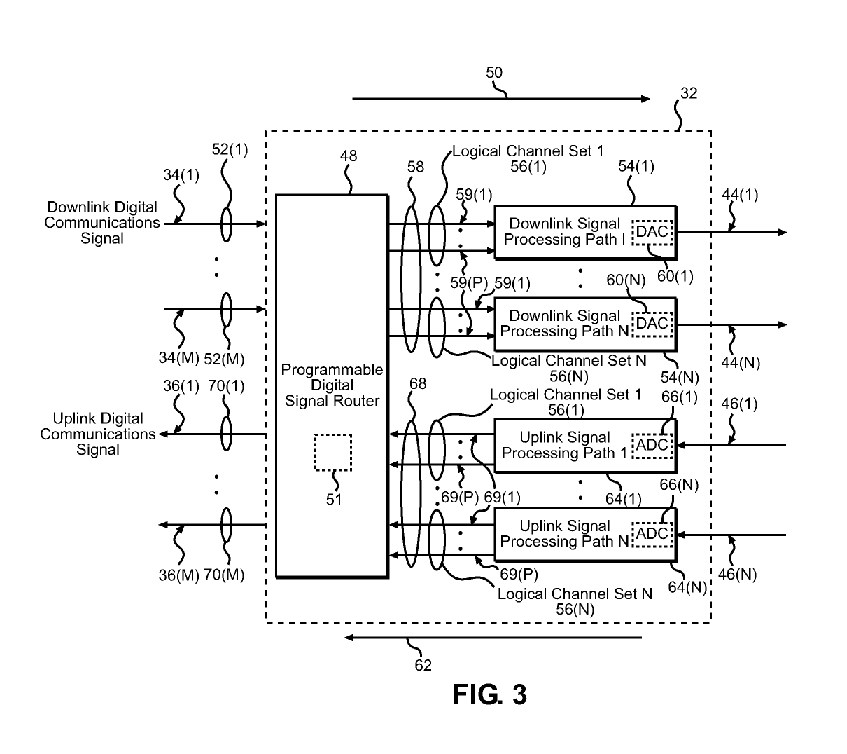

In this regard, FIG. 3 is a schematic diagram of the programmable head-end unit 32 in FIG. 2 configured to serve as an interface of analog DAS 30 (not shown) in FIG. 2 to the one or more digital signal sources 38(1)-38(M) (not shown) in FIG. 2. Common elements between FIGS. 2 and 3 are shown therein with common element numbers, thus will not be re-described herein.

With reference to FIG. 3, the programmable head-end unit 32 comprises a programmable digital signal router 48 configured to cross connect the one or more downlink digital communications signals 34(1)-34(M) with the one or more remote unit groups 40(1)-40(N) based on the one or more logical channels associated with each of the one or more downlink digital communications signals 34(1)-34(M). In a non-limiting example, the programmable digital signal router 48 is software-defined and may be implemented in a field programmable gate array (FPGA). In a downlink direction 50, the programmable digital signal router 48 receives the one or more downlink digital communications signals 34(1)-34(M) from the one or more digital signal sources 38(1)-38(M) (shown in FIG. 2), respectively. As previously stated in FIG. 2, each of the one or more downlink digital communications signals 34(1)-34(M) is associated with one or more logical channels. Hence, there may be a plurality of logical channels carried in the one or more downlink digital communications signals 34(1)-34(M). In a non-limiting example, each logical channel may be configured to indicate a specific wireless service, a specific RF band, a specific RF channel, and/or a specific wireless service location of an associated downlink digital communications signal. On the other hand, each of the one or more remote unit groups 40(1)-40(N) (not shown) may be configured to support a combination of wireless services, a combination of RF bands, a combination of RF channels, and/or a combination of wireless service locations. As a result, each of the one or more remote unit groups 40(1)-40(N) may correspond to a mixture of logical channels that are associated with more than one of the one or more downlink digital communications signals 34(1)-34(M). In this regard, by providing a logical channel mapping mechanism 51 (e.g., a mapping table, a routing table, etc.) at the programmable digital signal router 48, it is possible to route any of the one or more downlink digital communications signals 34(1)-34(M) to any of the one or more remote unit groups 40(1)-40(N) (not shown) based on any of the one or more logical channels associated with the downlink digital communications signal being routed. For the convenience of reference in the present disclosure, the one or more logical channels associated with each of the one or more downlink digital communications signals 34(1)-34(M) are collectively referred to as a logical channel group. In this regard, the one or more downlink digital communications signals 34(1)-34(M) are associated with one or more logical channel groups 52(1)-52(M), respectively.

With continuing reference to FIG. 3, the programmable head-end unit 32 further comprises one or more downlink signal-processing paths 54(1)-54(N), each associated with a respective remote unit group among the one or more remote unit groups 40(1)-40(N). As discussed above, each of the one or more remote unit groups 40(1)-40(N) may correspond to a mixture of logical channels. For the convenience of reference, the mixture of logical channels corresponding to each of the one or more remote unit groups 40(1)-40(N) (FIG. 2) is referred to as a logical channel set. In this regard, the one or more downlink signal-processing paths 54(1)-54(N) are associated with one or more logical channel sets 56(1)-56(N), respectively. A logical channel set 56 among the one or more logical channel sets 56(1)-56(N) that is associated with any of the one or more downlink signal-processing paths 54(1)-54(N) comprises the mixture of logical channels of a respective remote unit group among the one or more remote unit groups 40(1)-40(N) that is associated with the respective downlink signal-processing path.

With continuing reference to FIG. 3, to facilitate routing based on the logical channel mapping mechanism 51, the programmable digital signal router 48 generates a plurality of downlink digital baseband signals 58 from the one or more downlink digital communications signals 34(1)-34(M). Each of the plurality of downlink digital baseband signals 58 is associated with a respective logical channel. In this regard, in a non-limiting example, if the downlink digital communications signal 34(1) is associated with the logical channel group 52(1) comprising logical channels 1, 2, and 3, the programmable digital signal router 48 will generate three downlink digital baseband signals corresponding to the logical channels 1, 2, and 3, respectively, for the downlink digital communications signal 34(1). Each of the plurality of downlink digital baseband signals 58 is programmably assigned to one or more of the one or more logical channel sets 56(1)-56(N) by the programmable digital signal router 48 based on the logical channel mapping mechanism 51. In this regard, each of the one or more downlink signal-processing paths 54(1)-54(N) may receive one or more downlink digital baseband signals 59(1)-59(P) among the plurality of downlink digital baseband signals 58, wherein ‘P’ may be different integers in the one or more downlink signal-processing paths 54(1)-54(N). The one or more downlink signal-processing paths 54(1)-54(N) further comprise one or more DACs 60(1)-60(N), respectively. In a non-limiting example, the one or more digital-to-analog converters (DACs) 60(1)-60(N) are broadband DACs. The one or more DACs 60(1)-60(N) are configured to generate the one or more downlink analog RF signals 44(1)-44(N) for the one or more remote unit groups 40(1)-40(N) (not shown), respectively.

With continuing reference to FIG. 3, in an uplink direction 62, the programmable head-end unit 32 comprises one or more uplink signal-processing paths 64(1)-64(N), each paired with a corresponding downlink signal-processing path among the one or more downlink signal-processing paths 54(1)-54(N). In a non-limiting example, the uplink signal-processing path 64(1) pairs with the downlink signal-processing path 54(1), the uplink signal-processing path 64(2) pairs with the downlink signal-processing path 54(2), and so on. As such, each of the one or more uplink signal-processing paths 64(1)-64(N) is also associated with the same remote unit group and the same logical channel set of the corresponding downlink signal-processing path. For example, the uplink signal-processing path 64(1) is associated with the remote unit group 40(1) (not shown) and the logical channel set 56(1), the uplink signal-processing path 64(2) is associated with the remote unit group 40(2) and the logical channel set 56(2), and so on.

With continuing reference to FIG. 3, the one or more uplink signal-processing paths 64(1)-64(N) comprise one or more ADCs 66(1)-66(N), respectively. In a non-limiting example, the one or more analog-to-digital converters (ADCs) 66(1)-66(N) are broadband ADCs. The one or more uplink signal-processing paths 64(1)-64(N) are configured to receive the one or more uplink analog RF signals 46(1)-46(N) and generate a plurality of uplink digital baseband signals 68. In this regard, each of the one or more uplink signal-processing paths 64(1)-64(N) may generate one or more uplink digital baseband signals 69(1)-69(P), wherein P may be different integers in the one or more uplink signal-processing paths 64(1)-64(N). Each of the plurality of uplink digital baseband signals 68 is associated with a respective logical channel. The programmable digital signal router 48 programmably routes each of the plurality of uplink digital baseband signals 68 to one or more of the one or more digital signal sources 38(1)-38(M) (not shown) based on the logical channel mapping mechanism 51. As a result, the programmable digital signal router 48 generates the one or more uplink digital communications signals 36(1)-36(M) to be provided to the one or more digital signal sources 38(1)-38(M) (not shown), respectively. Similar to the one or more downlink digital communications signals 34(1)-34(M), the one or more uplink digital communications signals 36(1)-36(M) are associated with one or more logical channel groups 70(1)-70(M), respectively. Each of the one or more logical channel groups 70(1)-70(M) comprises one or more logical channels. In this regard, each of the one or more uplink digital communications signals 36(1)-36(M) is an aggregated uplink digital communications signal comprising one or more uplink digital baseband signals mapped to the uplink digital communications signal by the logical channel mapping mechanism 51 in the programmable digital signal router 48. In a non-limiting example, if three uplink digital baseband signals corresponding to logical channels 4, 5, and 6, respectively, are mapped to the uplink digital communications signal 36(1) by the logical channel mapping mechanism 51, the uplink digital communications signal 36(1) provided to the digital signal source 38(1) (not shown) will be an aggregated uplink digital communications signal of the three uplink digital baseband signals. Further, the uplink digital communications signal 36(1) is associated with the logical channel group 70(1) comprising the logical channels 4, 5, and 6.

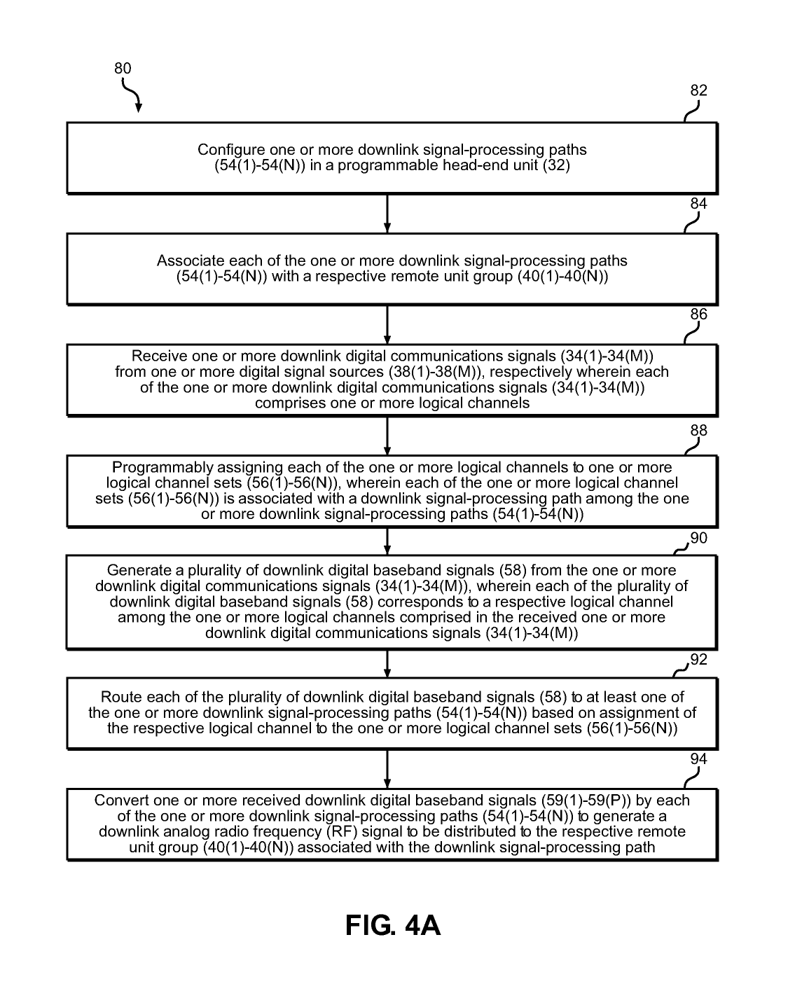

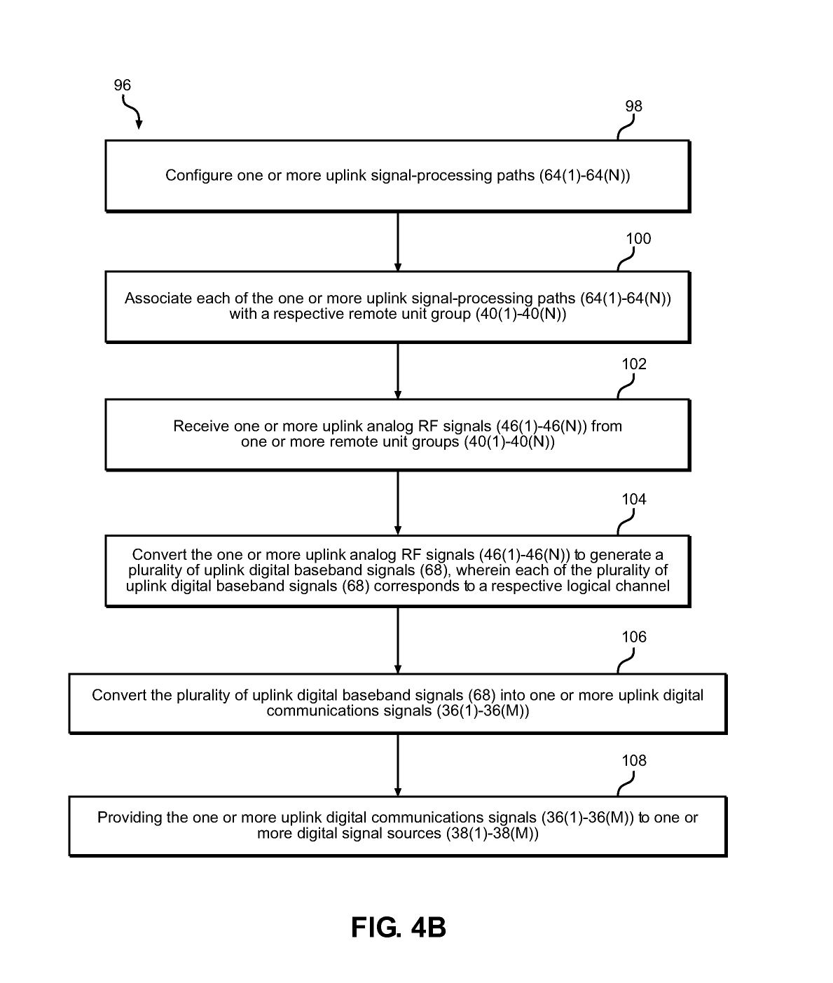

To facilitate describing exemplary processes that can be performed by the programmable head-end unit 32 in FIG. 3 for distributing downlink digital communications signals 34(1)-34(M) in the analog DAS 30 in FIG. 2, FIG. 4A is provided. FIG. 4A is a flowchart of an exemplary downlink distribution process 80 performed by the programmable head-end unit 32 in FIG. 3 to distribute the one or more downlink digital communications signals 34(1)-34(M) in the analog DAS 30 in FIG. 2.

According to the downlink distribution process 80, the programmable head-end unit 32 is configured with the one or more downlink signal-processing paths 54(1)-54(N) (block 82). Each of the one or more downlink signal-processing paths 54(1)-54(N) is associated with a respective remote unit group 40(1)-40(N) (block 84). The programmable head-end unit 32 receives the one or more downlink digital communications signals 34(1)-34(M) from the one or more digital signal sources 38(1)-38(M), respectively, wherein each of the one or more downlink digital communications signals 34(1)-34(M) comprises one or more logical channels (block 86). The programmable head-end unit 32 then programmably assigns each of the one or more logical channels to one or more logical channel sets 56(1)-56(N), wherein each of the one or more logical channel sets 56(1)-56(N) is associated with a downlink signal-processing path among the one or more downlink signal-processing paths 54(1)-54(N) (block 88). Next, the programmable head-end unit 32 generates the plurality of downlink digital baseband signals 58 from the one or more downlink digital communications signals 34(1)-34(M) wherein each of the plurality of downlink digital baseband signals 58 corresponds to a respective logical channel among the one or more logical channels comprised in the received one or more downlink digital communications signals 34(1)-34(M) (block 90). The programmable head-end unit 32 subsequently routes each of the plurality of downlink digital baseband signals 58 to at least one of the one or more downlink signal-processing paths 54(1)-54(N) based on assignment of the respective logical channel to the one or more logical channel sets 56(1)-56(N) (block 92). As previously discussed, the routing is based on mapping the respective logical channel to the one or more logical channel sets 56(1)-56(N) that are associated with the one or more downlink signal-processing paths 54(1)-54(N). Finally, each of the one or more downlink signal-processing paths 54(1)-54(N) converts one or more received downlink digital baseband signals 59(1)-59(P) to generate a downlink analog RF signal to be distributed to the respective remote unit group 40(1)-40(N) associated with the downlink signal-processing path (block 94).

To facilitate describing exemplary processes that can be performed by the programmable head-end unit 32 in FIG. 3 for distributing uplink digital communications signals 36(1)-36(M) in the analog DAS 30 in FIG. 2, FIG. 4B is provided. FIG. 4B is a flowchart of an exemplary uplink distribution process 96 performed at the programmable head-end unit 32 in FIG. 3 to distribute the one or more uplink digital communications signals 36(1)-36(M) in the analog DAS 30 in FIG. 2. Elements in FIGS. 2 and 3 are referenced in connection with FIG. 4B and will not be re-described herein.

According to the uplink distribution process 96 in FIG. 4B, the programmable head-end unit 32 is configured with the one or more uplink signal-processing paths 64(1)-64(N) (block 98). Each of the one or more uplink signal-processing paths 64(1)-64(N) is associated with a respective remote unit group 40(1)-40(N) (block 100). The one or more uplink signal-processing paths 64(1)-64(N) receive the one or more uplink analog RF signals 46(1)-46(N) from the one or more remote unit groups 40(1)-40(N), respectively (block 102). Next, the one or more uplink signal-processing paths 64(1)-64(N) convert the one or more uplink analog RF signals 46(1)-46(N) to generate a plurality of uplink digital baseband signals 68 wherein each of the plurality of uplink digital baseband signals 68 corresponds to a respective logical channel (block 104). Subsequently, the programmable digital signal router 48 converts the plurality of uplink digital baseband signals 68 into the one or more uplink digital communications signals 36(1)-36(M) (block 106). Finally, the programmable digital signal router 48 provides the one or more uplink digital communications signals 36(1)-36(M) to one or more digital signal sources 38(1)-38(M) (block 108).

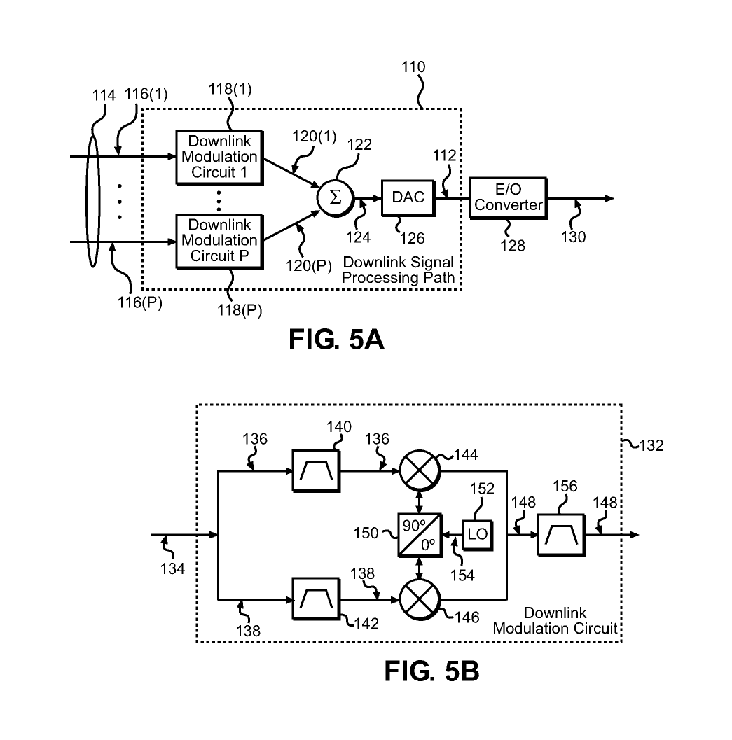

As previously discussed above with regard to the programmable head-end unit 32 in FIG. 3, the one or more downlink signal-processing paths 54(1)-54(N) are configured to convert the plurality of downlink digital baseband signals 58 into the one or more downlink analog RF signals 44(1)-44(N) for distribution to the one or more remote unit groups 40(1)-40(N), respectively. In this regard, FIG. 5A is a schematic diagram of an exemplary downlink signal-processing path 110, which may be any of the one or more downlink signal-processing paths 54(1)-54(N) in FIG. 3, configured to generate a respective downlink analog RF signal 112 for distribution to a respective remote unit group. Elements in FIG. 3 are reference in connection with FIG. 5A and will not be re-described herein.

With reference to FIG. 5A, the downlink signal-processing path 110 is associated with a respective logical channel set 114, which may by any of the one or more logical channel sets 56(1)-56(N) (not shown), comprising one or more logical channels. The downlink signal-processing path 110 receives one or more downlink digital baseband signals 116(1)-116(P), which are equivalent to the one or more downlink digital baseband signals 59(1)-59(P) received by each of the one or more downlink signal-processing paths 54(1)-54(N) in FIG. 3. The downlink signal-processing path 110 comprises one or more downlink modulation circuits 118(1)-118(P) configured to convert the one or more downlink digital baseband signals 116(1)-116(P) into one or more downlink digital RF signals 120(1)-120(P), respectively. The downlink signal-processing path 110 also comprises a digital signal combiner 122 configured to receive and convert the one or more downlink digital RF signals 120(1)-120(P) to generate a combined downlink digital RF signal 124. A DAC 126 is configured to receive and convert the combined downlink digital RF signal 124 into the respective downlink analog RF signal 112. In a non-limiting example, the respective downlink analog RF signal 112 may be distributed to the respective remote unit group (not shown) over a downlink optical fiber (not shown). In this regard, an electrical-to-optical (E/O) converter 128 is provided and configured to convert the respective downlink analog RF signal 112 into a respective downlink optical RF signal 130 to be distributed over the downlink optical fiber (not shown).

With continuing reference to FIG. 5A, each of the one or more downlink digital baseband signals 116(1)-116(P) may comprise an in-phase (I) signal and a quadrature (Q) signal. In this regard, FIG. 5B is a schematic diagram of an exemplary downlink modulation circuit 132, which may be any of the one or more downlink modulation circuits 118(1)-118(P) in FIG. 5A, configured to modulate a downlink digital baseband signal 134 comprising a downlink I signal 136 and a downlink Q signal 138.

With reference to FIG. 5B, the downlink modulation circuit 132 comprises a downlink I signal filter 140 and a downlink Q signal filter 142 configured to attenuate unwanted parts in the downlink I signal 136 and the downlink Q signal 138, respectively. A downlink I signal modulator 144 and a downlink Q signal modulator 146 modulate the downlink I signal 136 and downlink Q signal 138, respectively, to generate a downlink digital RF signal 148. The downlink digital RF signal 148 may be any of the one or more downlink digital RF signals 120(1)-120(P) in FIG. 5A. A downlink phase shifter 150 is coupled to the downlink I signal modulator 144 and the downlink Q signal modulator 146 to maintain orthogonality between the downlink I signal 136 and the downlink Q signal 138, respectively, in the downlink digital RF signal 148. A downlink oscillator 152 is coupled to the downlink phase shifter 150 to provide a modulation frequency 154 for the downlink digital RF signal 148. The downlink modulation circuit 132 further comprises a downlink digital RF signal filter 156 configured to attenuate unwanted parts in the downlink digital RF signal 148.

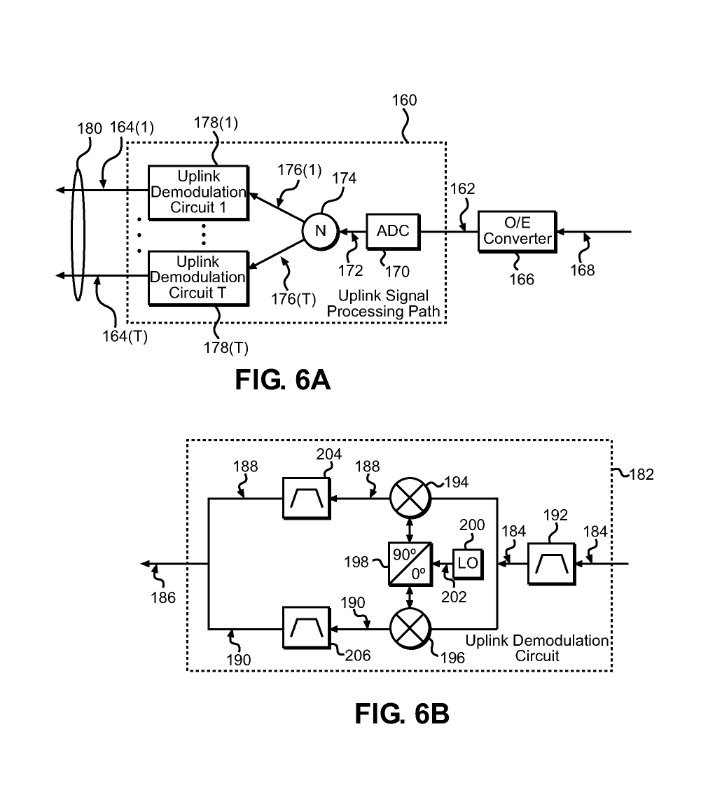

As previously discussed in FIG. 3, in the uplink direction 62, the one or more uplink signal-processing paths 64(1)-64(N) are configured to convert the one or more uplink analog RF signals 46(1)-46(N) into a plurality of uplink digital baseband signals 68. In this regard, FIG. 6A is a schematic diagram of an exemplary uplink signal-processing path 160, which may be any of the one or more uplink signal-processing paths 64(1)-64(N) in FIG. 3, configured to convert a respective uplink analog RF signal 162 into one or more respective uplink digital baseband signals 164(1)-164(T). Elements in FIG. 3 are referenced in connection with FIG. 6A and will not be re-described herein.

With reference to FIG. 6A, in a non-limiting example, the respective uplink analog RF signal 162 may be received from a respective remote unit group (not shown) over an uplink optical fiber (not shown). In this regard, an optical-to-electrical (O/E) converter 166 is first configured to receive and convert an uplink optical RF signal 168 into the respective uplink analog RF signal 162. An ADC 170 then converts the respective uplink analog RF signal 162 into a combined uplink digital RF signal 172. A digital signal splitter 174 subsequently splits the combined uplink digital RF signal 172 into one or more uplink digital RF signals 176(1)-176(T), wherein ‘T’ may be any real positive integer. The uplink signal-processing path 160 further comprises one or more uplink demodulation circuits 178(1)-178(T) configured to receive and convert the one or more uplink digital RF signals 176(1)-176(T) into the one or more respective uplink digital baseband signals 164(1)-164(T). The one or more respective uplink digital baseband signals 164(1)-164(T) are equivalent to the one or more uplink digital baseband signals 69(1)-69(P) generated by each of the one or more uplink signal-processing paths 64(1)-64(N). Each of the one or more respective uplink digital baseband signals 164(1)-164(T) is associated with a respective logical channel. In this regard, the logical channels of the one or more respective uplink digital baseband signals 164(1)-164(T) are comprised in a respective logical channel set 180 associated with the uplink signal-processing path 160.

With continuing reference to FIG. 6A, each of the one or more respective uplink digital baseband signals 164(1)-164(T) may comprise an I signal and a Q signal. In this regard, FIG. 6B is a schematic diagram of an exemplary uplink demodulation circuit 182, which may be any of the one or more uplink demodulation circuits 178(1)-178(T) in FIG. 6A, configured to demodulate an uplink digital RF signal 184 to generate an uplink digital baseband signal 186 comprising an uplink I signal 188 and an uplink Q signal 190.

With reference to FIG. 6B, an uplink digital RF signal filter 192 receives the uplink digital RF signal 184, which may be any of the one or more uplink digital RF signals 176(1)-176(T) in FIG. 6A, and attenuates unwanted parts in the uplink digital RF signal 184. An uplink I signal demodulator 194 and an uplink Q signal demodulator 196 demodulate the uplink digital RF signal 184 to generate the uplink I signal 188 and the uplink Q signal 190, respectively, in the uplink digital baseband signal 186. An uplink phase shifter 198 is coupled to the uplink I signal demodulator 194 and the uplink Q signal demodulator 196 to phase-shift the uplink I signal 188 and the uplink Q signal 190. An uplink oscillator 200 is coupled to the uplink phase shifter 198 to provide a reference frequency 202 for the uplink digital baseband signal 186. An uplink I signal filter 204 and an uplink Q signal filter 206 are configured to attenuate unwanted parts in the uplink I signal 188 and the uplink Q signal 190, respectively. As such, the uplink demodulation circuit 182 generates the uplink digital baseband signal 186 comprising the uplink I signal 188 and the uplink Q signal 190.

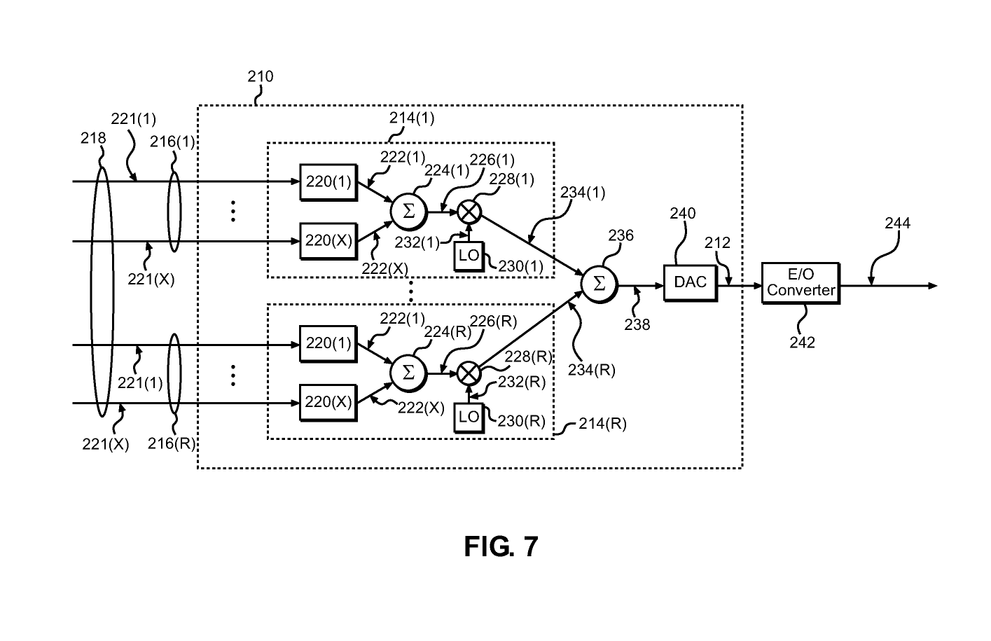

As previously discussed in FIG. 3, the one or more downlink signal-processing paths 54(1)-54(N) are associated with the one or more remote unit groups 40(1)-40(N), respectively. Each of the one or more remote unit groups 40(1)-40(N) may be configured to support a combination of wireless services, a combination of RF bands, a combination of RF channels, and/or a combination of wireless service locations. For these reasons, each of the one or more downlink signal-processing paths 54(1)-54(N) may be required to support a wide range of wireless services, RF bands, and/or RF channels. As a result, each of the one or more downlink signal-processing paths 54(1)-54(N) is required to handle a larger RF bandwidth (e.g., RF bands and/or channels). This may lead to increased electrical component (e.g., modulators, combiners, and filters) costs in the programmable head-end unit 32 in FIG. 3. In some cases, it may be desirable to provide a lower cost solution for the programmable head-end unit 32 in FIG. 3. In this regard, FIG. 7 is a schematic diagram of an exemplary double-conversion downlink signal-processing path 210, which may be any of the one or more downlink signal-processing paths 54(1)-54(N) in FIG. 3, configured to generate a respective downlink analog RF signal 212 for distribution to a respective remote unit group among the one or more remote unit groups 40(1)-40(N) (not shown). Elements in FIG. 3 are referenced in connection with FIG. 7 and will not re-described herein.

With reference to FIG. 7, to help ease the RF bandwidth requirement on each of the one or more downlink signal-processing paths 54(1)-54(N), the double-conversion downlink signal-processing path 210 is divided into one or more downlink signal-processing sub-paths 214(1)-214(R), wherein ‘R’ may be any real positive integer. Each of the one or more downlink signal-processing sub-paths 214(1)-214(R) is configured to process a respective RF band among the one or more RF bands 216(1)-216(R) associated with the double-conversion downlink signal-processing path 210. By configuring each of the one or more downlink signal-processing sub-paths 214(1)-214(R) to process a signal RF band, RF bandwidth requirement on the downlink signal-processing sub-path is reduced, thus leading to reduced electrical component (e.g., modulators, combiners, and filters) costs in the programmable head-end unit 32 in FIG. 3.

With continuing reference to FIG. 7, the double-conversion downlink signal-processing path 210 receives one or more downlink digital baseband signals 218 from the programmable digital signal router 48 (not shown). Each of the one or more downlink digital baseband signals 218 is programmably assigned to one of the one or more downlink signal-processing sub-paths 214(1)-214(R) based on an associated RF band of the downlink digital baseband signal 218. Each of the one or more downlink signal-processing sub-paths 214(1)-214(R) comprises one or more downlink modulation circuits 220(1)-220(X), wherein X may be different among the one or more downlink signal-processing sub-paths 214(1)-214(R). In addition, each of the one or more downlink signal-processing sub-paths 214(1)-214(R) receives one or more respective downlink digital baseband signals 221(1)-221(X). The one or more downlink modulation circuits 220(1)-220(X) convert the one or more respective downlink digital baseband signals 221(1)-221(X) into one or more downlink digital intermediate frequency (IF) signals 222(1)-222(X), respectively.

With continuing reference to FIG. 7, the double-conversion downlink signal-processing path 210 also comprises one or more downlink combiners 224(1)-224(R), each associated with a respective downlink signal-processing sub-path among the one or more downlink signal-processing sub-paths 214(1)-214(R). The one or more downlink combiners 224(1)-224(R), each configured to combine the one or more respective downlink digital IF signals 222(1)-222(X) in the respective downlink signal-processing sub-path, generate one or more combined downlink digital IF signals 226(1)-226(R) among the one or more downlink signal-processing sub-paths 214(1)-214(R), respectively. The one or more downlink signal-processing sub-paths 214(1)-214(R) also comprise one or more downlink modulators 228(1)-228(R), respectively. Each of the one or more downlink modulators 228(1)-228(R) is coupled to a downlink oscillator among one or more downlink oscillators 230(1)-230(R), respectively. The one or more downlink oscillators 230(1)-230(R) are configured to provide one or more modulation reference frequencies 232(1)-232(R) to the one or more downlink modulators 228(1)-228(R), respectively. The one or more downlink modulators 228(1)-228(R) modulate the one or more combined downlink digital IF signals 226(1)-226(R) to generate one or more RF band-dependent downlink digital RF signals 234(1)-234(R), respectively. A downlink RF signal combiner 236 receives and combines the one or more RF band-dependent downlink digital RF signals 234(1)-234(R) to generate a combined downlink digital RF signal 238 for the double-conversion downlink signal-processing path 210. A DAC 240 subsequently converts the combined downlink digital RF signal 238 into the respective downlink analog RF signal 212. In a non-limiting example, the respective downlink analog RF signal 212 may be provided to a respective remote unit group (not shown) of a downlink optical fiber (not shown). In this regard, an E/O converter 242 receives and converts the respective downlink analog RF signal 212 to generate a respective downlink optical RF signal 244 for distribution to the respective remote unit group over the downlink optical fiber.

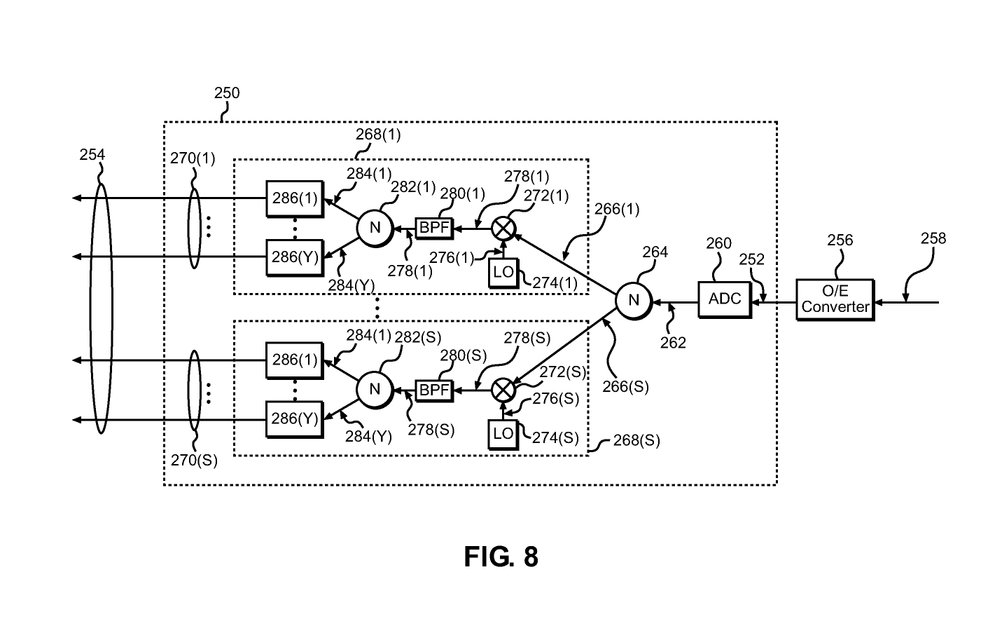

Concurrent to the double-conversion downlink signal-processing path 210 in FIG. 7, FIG. 8 provides a schematic diagram of an exemplary double-conversion uplink signal-processing path 250, which may be any of the one or more uplink signal-processing paths 64(1)-64(N) in FIG. 3, configured to convert a respective uplink analog RF signal 252 into one or more respective uplink digital baseband signals 254. Elements in FIG. 3 are referenced in connection with FIG. 8 and will not be re-described herein.

With reference to FIG. 8, in a non-limiting example, the double-conversion uplink signal-processing path 250 may receive the respective uplink analog RF signal 252 from a respective remote unit group over an uplink optical fiber. In this regard, an O/E converter 256 is configured to receive an uplink optical RF signal 258 from the respective remote unit group (not shown) over the uplink optical fiber (not shown). The O/E converter 256 then converts the uplink optical RF signal 258 to the respective uplink analog RF signal 252. An ADC 260 receives and converts the respective uplink analog RF signal 252 to generate a combined uplink digital RF signal 262.

With continuing reference to FIG. 8, an uplink RF signal splitter 264 receives and splits the combined uplink digital RF signal 262 to generate one or more RF band-dependent uplink digital RF signals 266(1)-266(S), wherein ‘S’ may be any real positive integer. The double-conversion uplink signal-processing path 250 also comprises one or more uplink signal-processing sub-paths 268(1)-268(S) corresponding to one or more RF bands 270(1)-270(S), respectively. In this regard, each of the one or more uplink signal-processing sub-paths 268(1)-268(S) is associated with a respective RF band among the one or more RF bands 270(1)-270(S). Each of the one or more RF band-dependent uplink digital RF signals 266(1)-266(S) is provided to one of the one or more uplink signal-processing sub-paths 268(1)-268(S) based on an associated RF band of the RF band-dependent uplink digital RF signal. The one or more uplink signal-processing sub-paths 268(1)-268(S) comprise one or more uplink demodulators 272(1)-272(S) configured to receive the one or more uplink digital RF signals 266(1)-266(S), respectively. One or more uplink oscillators 274(1)-274(S) are coupled to the one or more uplink demodulators 272(1)-272(S) to provide one or more demodulation reference frequencies 276(1)-276(S), respectively. The one or more uplink demodulators 272(1)-272(S) demodulate the one or more RF band-dependent uplink digital RF signals 266(1)-266(S) to generate one or more combined uplink digital IF signals 278(1)-278(S), respectively. Subsequently, one or more uplink filters 280(1)-280(S) are configured to attenuate unwanted parts in the one or more combined uplink digital IF signals 278(1)-278(S), respectively.

With continuing reference to FIG. 8, one or more uplink splitters 282(1)-282(S) are configured to receive the one or more combined uplink digital IF signals 278(1)-278(S), respectively. Each of the one or more uplink splitters 282(1)-282(S) is configured to split a respective combined uplink digital IF signal to generate one or more uplink digital IF signals 284(1)-284(Y), wherein Y may be different among the one or more uplink signal-processing sub-paths 268(1)-268(S). Each of the one or more uplink signal-processing sub-paths 268(1)-268(S) further comprises one or more uplink demodulation circuits 286(1)-286(Y), wherein Y may be different among the one or more uplink signal-processing sub-paths 268(1)-268(S). Each of the one or more uplink demodulation circuits 286(1)-286(Y) is configured to receive and convert one of the one or more uplink digital IF signals 284(1)-284(Y) to generate an uplink digital baseband signal. In this regard, the one or more uplink signal-processing sub-paths 268(1)-268(S) generate the one or more respective uplink digital baseband signals 254 for the double-conversion uplink signal-processing path 250.

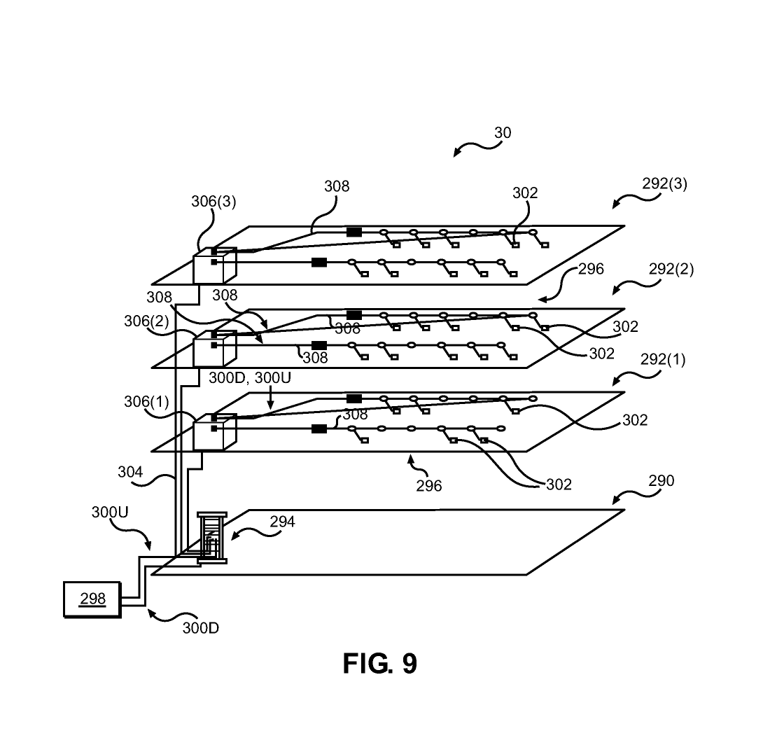

The analog DAS 30 in FIG. 2 may be provided in an indoor environment, as illustrated in FIG. 9. FIG. 9 is a partially schematic cut-away diagram of an exemplary building infrastructure in which an analog DAS, including the analog DAS 30 in FIG. 2 and the programmable head-end unit 32 in FIG. 3 can be employed. The building infrastructure 290 in this embodiment includes a first (ground) floor 292(1), a second floor 292(2), and a third floor 292(3). The floors 292(1)-292(3) are serviced by a central unit 294, which may be the programmable head-end unit 32 in FIG. 3, to provide antenna coverage areas 296 in the building infrastructure 290. The central unit 294 is communicatively coupled to a base station 298 to receive downlink communications signals 300D from the base station 298. The central unit 294 is communicatively coupled to remote antenna units 302 to receive uplink communications signals 300U from the remote antenna units 302, as previously discussed above. The downlink and uplink communications signals 300D, 300U communicated between the central unit 294 and the remote antenna units 302 are carried over a riser cable 304. The riser cable 304 may be routed through interconnect units (ICUs) 306(1)-306(3) dedicated to each of the floors 292(1)-292(3) that route the downlink and uplink communications signals 300D, 300U to the remote antenna units 292 and also provide power to the remote antenna units 302 via array cables 308.

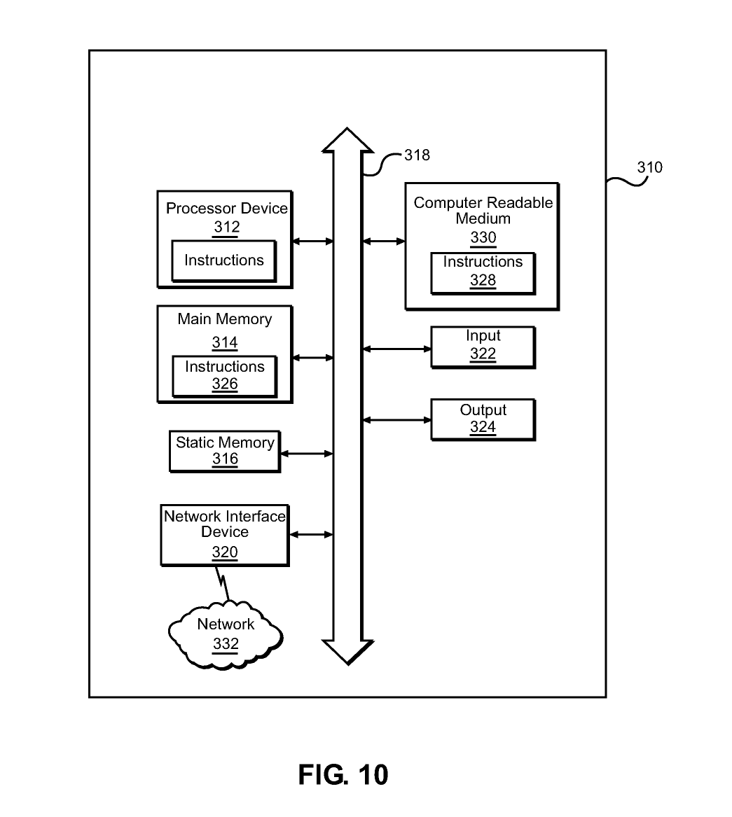

FIG. 10 is a schematic diagram representation of additional detail illustrating a computer system 310 that could be employed in the programmable head-end unit 32 in FIG. 2 for distributing the one or more downlink digital communications signals 34(1)-34(M) and the one or more uplink digital communications signals 36(1)-36(M) in the analog DAS 30 in FIG. 2. In this regard, the computer system 310 is adapted to execute instructions from an exemplary computer-readable medium to perform these and/or any of the functions or processing described herein. Elements in FIG. 2 are referenced in connection to FIG. 10 and will not be re-described herein.

In this regard, the computer system 310 in FIG. 10 may include a set of instructions that may be executed to route the one or more downlink digital communications signals 34(1)-34(M) to the one or more remote unit groups 40(1)-40(N) and to route the one or more uplink digital communications signals 36(1)-36(M) from the one or more remote unit groups 40(1)-40(N) to the one or more digital signal sources 38(1)-38(M). The computer system 310 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 310 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 310 in this embodiment includes a processing device or processor 312, a main memory 314 (e.g., read-only memory (ROM), flash memory, dynamic random access memory (DRAM), such as synchronous DRAM (SDRAM), etc.), and a static memory 316 (e.g., flash memory, static random access memory (SRAM), etc.), which may communicate with each other via a data bus 318. The main memory 314 may include instructions that can be executed by the processor 312. Alternatively, the processor 312 may be connected to the main memory 314 and/or static memory 316 directly or via some other connectivity means. The processor 312 may be a controller, and the main memory 314 or static memory 316 may be any type of memory.

The processor 312 represents one or more general-purpose processing devices, such as a microprocessor, central processing unit, or the like. More particularly, the processor 312 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 312 is configured to execute processing logic in instructions for performing the operations and steps discussed herein.

The computer system 310 may further include a network interface device 320. The computer system 310 also may or may not include an input 322, configured to receive input and selections to be communicated to the computer system 310 when executing instructions. The computer system 310 also may or may not include an output 324, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 310 may or may not include a data storage device that includes instructions 326 stored in the main memory 314 and instructions 328 stored in a computer-readable medium 330. The instructions 328 may also reside, completely or at least partially, within the main memory 314 and/or within the processor 312 during execution thereof by the computer system 310, the main memory 314 and the processor 312 also constituting computer-readable medium. The instructions 328 may further be transmitted or received over a network 332 via the network interface device 320. The instructions 328 may include instructions that can be executed by the programmable head-end unit 32 (not shown) to distribute the one or more downlink digital communications signals 34(1)-34(M) (not shown) and the one or more uplink digital communications signals 36(1)-36(M) (not shown) in the analog DAS 30 (not shown).

While the computer-readable medium 330 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A programmable head-end unit configured to distribute multi-band/multi-channel digital communications signals to one or more remote unit groups in an analog distributed antenna system (DAS), comprising:
one or more downlink signal-processing paths each associated with a respective remote unit group, wherein each remote unit group comprises at least one remote unit; and
a programmable digital signal router configured to:
receive one or more downlink digital communications signals from one or more digital signal sources, wherein each of the one or more downlink digital communications signals comprises one or more logical channels;
programmably assign each of the one or more logical channels to one or more logical channel sets, wherein each of the one or more logical channel sets is associated with a downlink signal-processing path among the one or more downlink signal-processing paths;
generate a plurality of downlink digital baseband signals each corresponding to a respective logical channel among the one or more logical channels comprised in the received one or more downlink digital communications signals; and
route each of the plurality of downlink digital baseband signals to at least one of the one or more downlink signal-processing paths based on assignment of the respective logical channel to the one or more logical channel sets;
wherein each of the one or more downlink signal-processing paths is configured to:
receive one or more downlink digital baseband signals among the plurality of downlink digital baseband signals from the programmable digital signal router; and
convert the one or more downlink digital baseband signals into a downlink analog radio frequency (RF) signal to be provided to the respective remote unit group associated with the downlink signal-processing path.

2. The programmable head-end unit of claim 1 further comprising one or more uplink signal-processing paths, wherein:
each uplink signal-processing path among the one or more uplink signal-processing paths is associated with a corresponding downlink signal-processing path among the one or more downlink signal-processing paths, wherein each uplink signal-processing path:
is associated with the remote unit group associated with the corresponding downlink signal-processing path; and
is associated with the logical channel set associated with the corresponding downlink signal-processing path;
each uplink signal-processing path of the one or more uplink signal-processing paths is configured to:
receive an uplink analog RF signal from the remote unit group associated with the corresponding downlink signal-processing path;
convert the uplink analog RF signal into one or more uplink digital baseband signals each comprising a logical channel; and
provide the one or more uplink digital baseband signals to the programmable digital signal router; and
the programmable digital signal router is configured to:
receive a plurality of uplink digital baseband signals from the one or more uplink signal-processing paths, wherein each of the plurality of the uplink digital baseband signals comprises a logical channel;
programmably assign each of the plurality of uplink digital baseband signals to at least one of the one or more digital signal sources based on the logical channel of the uplink digital baseband signal;
generate one or more uplink digital communications signals for the one or more digital signal sources, wherein each of the one or more uplink digital communications signals comprise one or more uplink digital baseband signals assigned to the digital signal source by the programmable digital signal router; and
provide the one or more uplink digital communications signals to the one or more digital signal sources, respectively.

3. The programmable head-end unit of claim 2, wherein the one or more digital signal sources are comprised of one or more digital baseband units (BBUs).

4. The programmable head-end unit of claim 3, wherein the one or more downlink digital communications signals are comprised of one or more downlink digital baseband signals having a common public radio interface (CPRI) format.

5. The programmable head-end unit of claim 2, wherein the one or more uplink digital communications signals are comprised of one or more uplink digital baseband signals having a common public radio interface (CPRI) format.

6. The programmable head-end unit according to claim 1, wherein each of the one or more uplink signal-processing paths comprises:
an analog-to-digital converter (ADC) configured to receive and convert the uplink analog RF signal into a combined uplink digital RF signal;
a digital signal splitter configured to split the combined uplink digital RF signal into one or more uplink digital RF signals; and
one or more uplink demodulation circuits each configured to:
receive an uplink digital RF signal among the one or more uplink digital RF signals; and
convert the received uplink digital RF signal into an uplink digital baseband signal among the one or more uplink digital baseband signals.

7. The programmable head-end unit of claim 6, wherein each of the one or more uplink demodulation circuits comprises:
an uplink digital RF signal filter configured to receive and attenuate unwanted parts in the uplink digital RF signal;
an uplink in-phase (I) signal demodulator and an uplink quadrature (Q) signal demodulator coupled to an uplink phase shifter and an uplink oscillator, the uplink I signal demodulator and the uplink Q signal demodulator are configured to demodulate the uplink digital RF signal to generate the uplink digital baseband signal comprising an uplink I signal and an uplink Q signal;
an uplink I signal filter configured to receive and attenuate unwanted parts in the uplink I signal comprised in the uplink digital baseband signal; and
an uplink Q signal filter configured to receive and attenuate unwanted parts of the uplink Q signal comprised in the uplink digital baseband signal.

8. The programmable head-end unit of claim 1, wherein each of the one or more uplink signal-processing paths further comprises one or more uplink signal-processing sub-paths, each uplink signal-processing path among the one or more uplink signal-processing paths is configured to:
programmably associate each of the one or more uplink signal-processing sub-paths with a respective RF band;
converts the uplink analog RF signal received from the respective remote unit group into a combined uplink digital RF signal;
split the combined uplink digital RF signal into one or more RF band-dependent uplink digital RF signals; and
programmably assign each of the one or more RF band-dependent uplink digital RF signals to one of the one or more uplink signal-processing sub-paths based on an associated RF band of the RF band-dependent uplink digital RF signal.

9. The programmable head-end unit of claim 8, wherein each of the one or more uplink signal-processing sub-paths comprises:
one or more uplink demodulators coupled to one or more uplink oscillators, respectively, wherein the one or more uplink demodulators are configured to demodulate one or more received RF band-dependent uplink digital RF signals to generate one or more combined uplink digital intermediate frequency (IF) signals;
one or more uplink splitters configured to receive and split the one or more combined uplink digital IF signals to generate one or more uplink digital IF signals; and
one or more uplink demodulation circuits, each configured to receive and convert one of the one or more uplink digital IF signals to generate an uplink digital baseband signal.

10. The programmable head-end unit of claim 1, wherein each of the one or more downlink signal-processing paths comprises:
one or more downlink modulation circuits each configured to:
receive a downlink digital baseband signal among the one or more downlink digital baseband signals received by the downlink signal-processing path, wherein the downlink digital baseband signal comprises a downlink in-phase (I) signal and a downlink quadrature (Q) signal; and
convert the downlink I signal and the downlink Q signal to generate a downlink digital RF signal;
a digital signal combiner coupled to the one or more downlink modulation circuits, configured to combine one or more downlink digital RF signals received from the one or more downlink modulation circuits to generate a combined downlink digital RF signal; and
a digital-to-analog converter (DAC) configured to receive and convert the combined downlink digital RF signal into the downlink analog RF signal.

11. The programmable head-end unit of claim 10, wherein each of the one or more downlink modulation circuits comprises:
a downlink I signal filter configured to receive and attenuate unwanted parts in the downlink I signal comprised in the downlink digital baseband signal;
a downlink Q signal filter configured to receive and attenuate unwanted parts in the downlink Q signal comprised in the downlink digital baseband signal;
a downlink I signal modulator and a downlink Q signal modulator coupled to a downlink phase shifter and a downlink oscillator, wherein the downlink I signal modulator and the downlink Q signal modulator are configured to modulate the downlink I signal and the downlink Q signal to generate the downlink digital RF signal; and
a downlink digital RF signal filter configured to receive and attenuate unwanted parts in the downlink digital RF signal.

12. The programmable head-end unit of claim 1, wherein each of the one or more downlink signal-processing paths further comprises one or more downlink signal-processing sub-paths and are configured to:
programmably associate each of the one or more downlink signal-processing sub-paths with a respective RF band;
programmably assign each of the one or more downlink digital baseband signals to one of the one or more downlink signal-processing sub-paths based on an associated RF band of the downlink digital baseband signal;
receive one or more RF band-dependent downlink digital RF signals from the one or more downlink signal-processing sub-paths;
combine the one or more RF band-dependent downlink digital RF signals to generate a combined downlink digital RF signal; and
convert the combined downlink digital RF signal into the downlink analog RF signal to be provided to the respective remote unit group associated with the downlink signal-processing path.

13. The programmable head-end unit of claim 12, wherein each of the one or more downlink signal-processing sub-paths comprises:
one or more downlink modulation circuits configured to convert one or more received downlink digital baseband signals to one or more downlink digital intermediate frequency (IF) signals, respectively;
a downlink combiner configured to combine the one or more downlink digital IF signals received from the one or more downlink modulation circuits to generate a combined downlink digital IF signal; and
a downlink modulator coupled to a downlink oscillator, wherein the downlink modulator is configured to modulate the combined downlink digital IF signal to generate an RF band-dependent downlink digital RF signal corresponding to the respective RF band.

14. A method for distributing multi-band/multi-channel digital communications signals in an analog distributed antenna system (DAS), comprising:
configuring one or more downlink signal-processing paths;
associating each of the one or more downlink signal-processing paths with a respective remote unit group;
receiving one or more downlink digital communications signals from one or more digital signal sources, respectively, wherein each of the one or more downlink digital communications signals comprises one or more logical channels;
programmably assigning each of the one or more logical channels to one or more logical channel sets, wherein each of the one or more logical channel sets is associated with a downlink signal-processing path among the one or more downlink signal-processing paths;
generating a plurality of downlink digital baseband signals from the one or more downlink digital communications signals, wherein each of the plurality of downlink digital baseband signals corresponds to a respective logical channel among the one or more logical channels comprised in the received one or more downlink digital communications signals;
routing each of the plurality of downlink digital baseband signals to at least one of the one or more downlink signal-processing paths based on assignment of the respective logical channel to the one or more logical channel sets; and
converting one or more received downlink digital baseband signals by each of the one or more downlink signal-processing paths to generate a downlink analog radio frequency (RF) signal to be provided to the respective remote unit group associated with the downlink signal-processing path.

15. The method of claim 14, further comprising:
configuring one or more uplink signal-processing paths;
associating each of the one or more uplink signal-processing paths with a respective remote unit group;
receiving one or more uplink analog RF signals by the one or more uplink signal-processing paths from one or more remote unit groups, respectively;
converting the one or more uplink analog RF signals to generate a plurality of uplink digital baseband signals, wherein each of the plurality of uplink digital baseband signals corresponds to a respective logical channel;
converting the plurality of uplink digital baseband signals into one or more uplink digital communications signals; and
providing the one or more uplink digital communications signals to the one or more digital signal sources, respectively.

16. The method according to claim 15, wherein converting the plurality of uplink digital baseband signals into one or more uplink digital communications signals further comprises aggregating one or more uplink digital baseband signals into each of the one or more uplink digital communications signals.

17. The method of claim 15, further comprising providing the one or more uplink digital communications signals encoded in a common public radio interface (CPRI) format to the one or more digital signal sources.

18. The method of claim 15, further comprising:
dividing each of the one or more uplink signal-processing paths into one or more uplink signal-processing sub-paths; and
associating each of the one or more uplink signal-processing sub-paths with a respective RF band.

19. The method of claim 14, further comprising receiving the one or more downlink digital communications signals encoded in a common public radio interface (CPRI) format from the one or more digital signal sources.

20. The method of claim 14, further comprising:
dividing each of the one or more downlink signal-processing paths into one or more downlink signal-processing sub-paths; and
associating each of the one or more downlink signal-processing sub-paths with a respective RF band.

21. An analog distributed antenna system (DAS), comprising:
one or more remote unit groups each comprising at least one remote unit;
a programmable head-end unit coupled to the one or more remote unit groups by at least one downlink communications medium and at least one uplink communications medium, wherein the programmable head-end unit comprises:
a programmable digital signal router communicatively coupled to one or more digital signal sources;
one or more downlink signal-processing paths communicatively coupled to the programmable digital signal router;
wherein the programmable digital signal router is configured to:
receive one or more downlink digital communications signals from the one or more digital signal sources, wherein each of the one or more downlink digital communications signals comprises one or more logical channels;
programmably assign each of the one or more logical channels to one or more logical channel sets, wherein each of the one or more logical channel sets is associated with a downlink signal-processing path among the one or more downlink signal-processing paths;
generate a plurality of downlink digital baseband signals each corresponding to a respective logical channel among the one or more logical channels comprised in the received one or more downlink digital communications signals; and
route each of the plurality of downlink digital baseband signals to at least one of the one or more downlink signal-processing paths based on assignment of the respective logical channel to the one or more logical channel sets;
one or more digital-to-analog converters (DACs) each coupled to a respective downlink signal-processing path among the one or more downlink signal-processing paths;
one or more uplink signal-processing paths communicatively coupled to the programmable digital signal router; and
one or more analog-to-digital converters (ADCs) each coupled to an uplink signal-processing path among the one or more uplink signal-processing paths.

22. The analog DAS of claim 21, wherein:
the at least one downlink communications medium is comprised of at least one downlink optical fiber; and
the at least one uplink communications medium is comprised of at least one uplink optical fiber.

23. The analog DAS of claim 22, further comprising:
an electrical-to-optical (E/O) converter coupled to the at least one downlink optical fiber and a DAC among the one or more DACs; and
one or more optical-to-electrical (O/E) converters coupled to the at least one uplink optical fiber and an ADC among the one or more ADCs.

24. The analog DAS of claim 21, wherein each of the one or more downlink signal-processing paths comprises:
one or more downlink modulation circuits, each comprising:
a downlink in-phase (I) signal filter;
a downlink I signal modulator coupled to the downlink I signal filter;
a downlink quadrature (Q) signal filter;
a downlink Q signal modulator coupled to the downlink Q signal filter;
a downlink phase shifter coupled to the downlink I signal modulator and the downlink Q signal modulator;
a downlink oscillator coupled to the downlink phase shifter;
a downlink digital radio frequency (RF) filter coupled to the downlink I signal modulator and the downlink Q signal modulator;
a digital signal combiner coupled to the one or more downlink modulation circuits; and
a digital-to-analog converter (DAC) coupled to the digital signal combiner.

25. The analog DAS of claim 21, wherein each of the one or more uplink signal-processing paths comprises:
an analog-to-digital converter (ADC);
a digital signal splitter coupled to the ADC; and
one or more uplink demodulation circuits coupled to the digital signal splitter,
wherein each of the one or more uplink demodulation circuits comprises:
an uplink digital radio frequency (RF) filter;
an uplink in-phase (I) signal modulator coupled to the uplink digital RF filter;
an uplink quadrature (Q) signal modulator coupled to the uplink digital RF filter;
an uplink phase shifter coupled to the uplink I signal modulator and the uplink Q signal modulator;
an uplink oscillator coupled to the uplink phase shifter;
an uplink I signal filter coupled to the uplink I signal modulator; and
an uplink Q signal filter coupled to the uplink Q signal modulator.

26. The analog DAS of claim 21, wherein each of the one or more downlink signal-processing paths comprises:
one or more downlink signal-processing sub-paths, each comprising:
one or more downlink modulation circuits;
a downlink combiner coupled to the one or more downlink modulation circuits;
a downlink modulator coupled to the downlink combiner; and
a downlink oscillator coupled to the downlink modulator;
a downlink radio frequency (RF) signal combiner coupled to the one or more downlink signal-processing sub-paths; and
a digital-to-analog converter (DAC) coupled to the downlink RF signal combiner.

27. The analog DAS of claim 21, wherein each of the one or more uplink signal-processing paths comprises:
an analog-to-digital converter (ADC);
an uplink radio frequency (RF) signal splitter coupled to the ADC; and
one or more uplink signal-processing sub-paths coupled to the uplink RF signal splitter, wherein each of the one or more uplink signal-processing sub-paths comprises:
an uplink demodulator coupled to the uplink RF signal splitter;
an uplink oscillator coupled to the uplink demodulator;
an uplink filter coupled to the uplink demodulator;
an uplink splitter coupled to the uplink filter; and
one or more uplink demodulation circuits coupled to the uplink splitter.

28. The analog DAS of claim 21, wherein the programmable digital signal router is a software-defined programmable head-end unit.

29. The analog DAS of claim 21, wherein the one or more DACs and the one or more ADCs are broadband DACs and broadband ADCs, respectively.
